(19) United States
(12) Patent Application Publication
(10) Pub. No.: US 2008/0291316 A1
(43) Pub. Date: Nov. 27, 2008

(54) IMAGE SENSOR PACKAGE STRUCTURE AND CAMERA MODULE HAVING SAME

(75) Inventor: CHUN-FANG CHENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/875,138

(22) Filed: Oct. 19, 2007

(30) Foreign Application Priority Data
May 25, 2007 (CN) 200710200703.9

(51) Int. Cl. H04N 5/225; H01J 5/02

(52) U.S. Cl. 348/340; 250/239; 348/E05.024

(57) ABSTRACT

An image sensor package structure includes a base board, an image sensor and at least a passive component. The base board includes a top surface, a bottom surface and four side surfaces. At least one depression is formed in the border of the top surface and the side surface. The image sensor is mechanically and electrically connected to the base board. The images sensor is installed above the depression. At least a passive component is installed in the depression and electrically connected to the base board.

### TECHNICAL FIELD

The present invention relates to image sensor package structures and cameras module having the same, and particularly, to a miniaturized image sensor package structure and a camera module having the same.

### BACKGROUND

In recent years, portable electronic devices like cellular phones have become popular with consumers. For a cellular phone, the image acquisition function is a new add-on function of the cellular phone. A camera module employed in the cellular phone for image acquisition requires not only enhanced output picture quality but also compact size. However, the package size of an image sensor in the camera module determines the volume size of the camera module. Therefore, an improved design of the image sensor is beneficial in achieving a miniaturized camera module.

Referring to FIG. 1, a typical image sensor package structure 100a is shown. The structure 100a includes an image sensor 11a, a number of passive components 12a and a base board 13a. The image sensor 11a and the passive components 12a are disposed on the base board 13a and are electrically connected to the base board 13a. The image sensor 11a is disposed in the center of the base board 13a. From a top view, the passive components 12a are disposed around the image sensor 11a. The structure of such image sensor tends to be bulky and, accordingly, the base board 13a needs a larger room to accommodate the image sensor 11a and the passive components 12a. This is adverse to a miniaturized image sensor package structure and restricts flexibility of the layout of the image sensor 11a.

### SUMMARY

In accordance with a present embodiment, an image sensor package structure and a camera module having the same are disclosed. The image sensor package structure includes a base board, an image sensor and at least a passive component. The base board includes a top surface, a bottom surface and four side surfaces. At least one depression is formed in the border of the top surface and the side surface. The image sensor is mechanically and electrically connected to the base board. The images sensor is installed above the depression. At least a passive component is installed in the depression and electrically connected to the base board.

Other advantages and novel features will be drawn from the following detailed description of present embodiments when conjunction with the attached drawings.

### BRIEF DESCRIPTION OF THE DRAWINGS

Many aspects of the present image sensor package structure can be better understood with reference to the following drawings. The components in the drawings are not necessarily drawn to scale, the emphasis instead being placed upon clearly illustrating the principles of the present image sensor package structure. Moreover, in the drawings, like reference numerals designate corresponding parts throughout the several views.

FIG. 1 is a schematic cross-sectional view of a typical image sensor package structure, according to a related art;

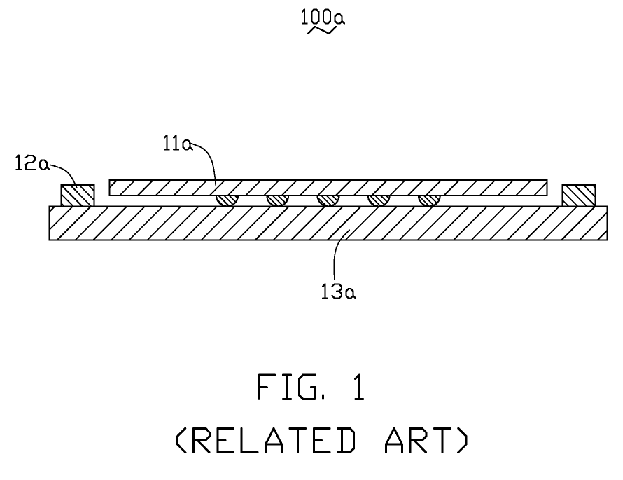

FIG. 2 is a schematic cross-sectional view of an image sensor package structure, according to a first present embodiment;

FIG. 3 is a top view of a base board of the image sensor package structure of FIG. 2;

FIG. 4 is a schematic cross-sectional view of an image sensor package structure, according to a second present embodiment;

FIG. 5 is a top view of a base board of an image sensor package structure according to a third present embodiment; and

FIG. 6 is a schematic cross-sectional view of a camera module employing the image sensor package structure of FIG. 2.

### DETAILED DESCRIPTION OF THE PREFERRED EMBODIMENT

Embodiments of the present image sensor package structure will now be described in detail below and with reference to the drawings.

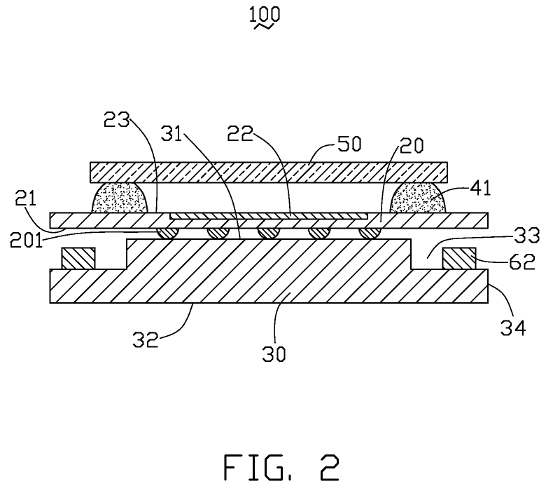

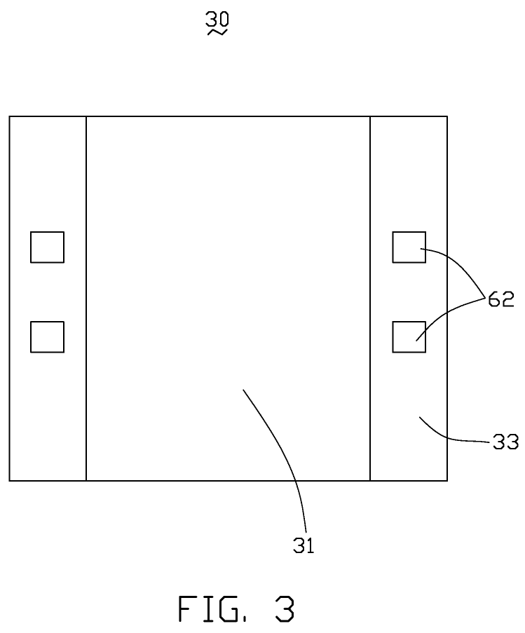

Referring to FIG. 2 and FIG. 3, an image sensor package 100 structure according to a first present embodiment includes a base board 30, an image sensor 20 and at least a passive component 62.

The base board 30 can be made from fiberglass, synthetic resin or ceramic materials. The base board 30 includes a top surface 31, four side surfaces 34 and a bottom surface 32. The top surface 31 is configured for carrying the image sensor 20 thereon. The image sensor 20 is electrically connected to the top surface 31 of the base board 30 by a number of soldering points 201 disposed on a bottom surface 21 of the image sensor 20. Two depressions 33 are formed in the border of the top surface 31 and two opposite side surfaces 34. The depth of the depressions 33 are smaller than that of the side surfaces 34. Preferably, the height of the depressions 33 is substantially equal to that of the passive component 62.

In practice, the depression 33 may be formed in at least one of the four side surfaces 34. Furthermore, the depression 33 can be adjacent arranged in three or four of the four side surfaces 24.

The passive components 62 are disposed inside the depressions 33 and are electrically connected with the base board 30. The passive components 62 are components configured for improving the transmission quality of the image sensor 20. The passive components 62 may be inducers, capacitors or resistant components.

The image sensor 20 may be a charge coupled device (CCD) or a complementary metal oxide semiconductor (CMOS) configured for transforming light signals into electrical signals. The image sensor 20 includes an upper surface and the bottom surface 21. The upper surface of the image sensor 20 defines a sensor area 22 and a non-sensor area 23 surrounding the sensor area 22. The soldering points 201 disposed on the bottom surface 21 can be one of ball grid array (BGA), leadless chip carrier (LCC) and lead frame package type. The image sensor 20 is mechanically and electrically connected to the base board 30 by the soldering points 201 disposed on the bottom surface 21. In this present embodiment, area size of the image sensor 20 is substantially equal or slightly greater than that of the bottom surface 32 of the base board 30. In a top-down projection, the image sensor 20 covers all areas of the base board 30. That is, when the image sensor 20 is placed above the base board 30, both the depression 33 and the passive component 62 are located beneath the image sensor 20 and are fully covered by the image sensor 20.

In this embodiment, the image sensor package structure further includes a transparent component 50 and a first adhesive 41 applied onto the non-sensor area 23. The transparent component 50 may be an IR cut filter configured for filtering incoming light. The transparent component 50 is attached to the non-sensor area 23 of the image sensor 20 by the first adhesive 41. The transparent component 50 seals the image sensor 20 with the first adhesive 41 to protect the sensor area 22 of the image sensor 20 from dust. In practice, the transparent component 50 may be an optical glass or other transparent material.

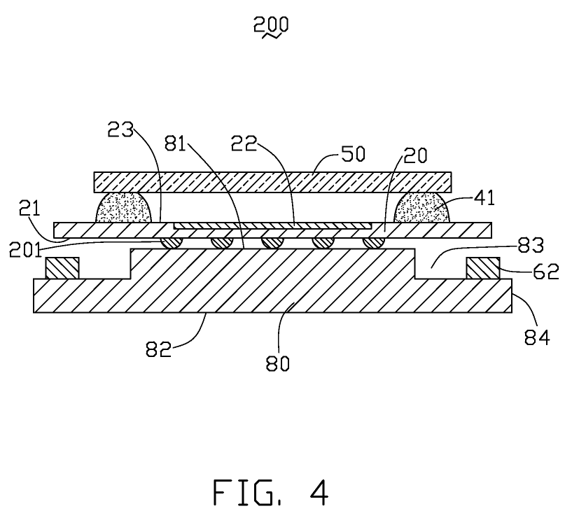

Referring to FIG. 4, an image sensor package structure 200 according to a second present embodiment is disclosed. The image sensor package structure 200 has a structure resembling that of the image sensor package structure 100 in the first embodiment, except that the area size of the image sensor 20 is slightly smaller than that of the base board 80.

The base board 80 includes a top surface 81, four side surfaces 84 and a bottom surface 82. The top surface 81 is configured for carrying the image sensor 20 thereon. The image sensor 20 is mechanically and electrically connected to the base board 80 by a number of soldering points 201 disposed on the bottom surface 21 of the image sensor 20. Two depressions 83 are formed in the border of the top surface 81 and two opposite side surfaces 84. Height of the depressions 83 is smaller than that of the side surfaces 84. Preferably, the height of the depressions 83 is substantially equal to that of the passive component 62.

In this embodiment, the area size of the image sensor 20 is slightly smaller than that of the bottom surface 82 of the base board 80 and the passive component 62 is disposed inside the depression 83. When the image sensor 20 is placed above the base board 80, the depression 83 is partly covered by the image sensor 20 in a top-down projection.

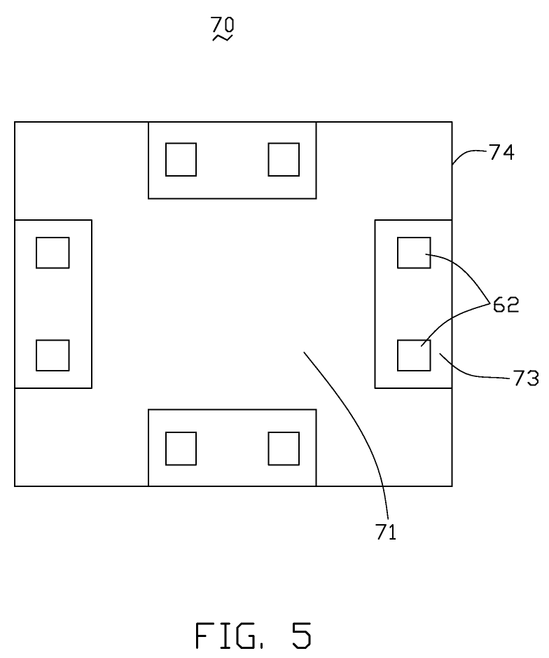

An image sensor package structure according to a third present embodiment has a structure basically resembling that of the image sensor package structures 100, 200 of the first and the second present embodiments but differing from the base board. Referring to FIG. 5, a top view of the base board 70 of the image sensor package structure in the third present embodiment is disclosed. The base board 70 is essentially identical to the base board 30 in the first present embodiment and the base board 80 in the second embodiment but four depressions 73 are partly formed in the side surfaces 74 of the base board 70. As illustrated in FIG. 5, taking one depression 73 as an example, a length of the depression 73 is smaller than that of the side surface 74. Different from the first and the second embodiments, the depressions 73 can be partly formed in the side surfaces 74. Height of the depressions 73 is smaller than that of the side surfaces 84. Preferably, the height of the depressions 73 is substantially equal to that of the passive component 62.

In this embodiment, area size of the image sensor 20 may be essentially equal to or slightly smaller than that of the base board 70 and the passive component 62 is disposed inside the depression 83. When the image sensor 20 is placed above the base board 70, the depression 83 is fully or partly covered by the image sensor 20 in a top-down projection and the passive component 62 is located beneath the bottom surface 21 of the image sensor 20.

It is understandable that, in actual practice, the number of depression 73 in this embodiment could be decreased accordingly. The base board 70 having at least one depression 73 formed in one of the four side surfaces 74 achieves the same purpose of this embodiment.

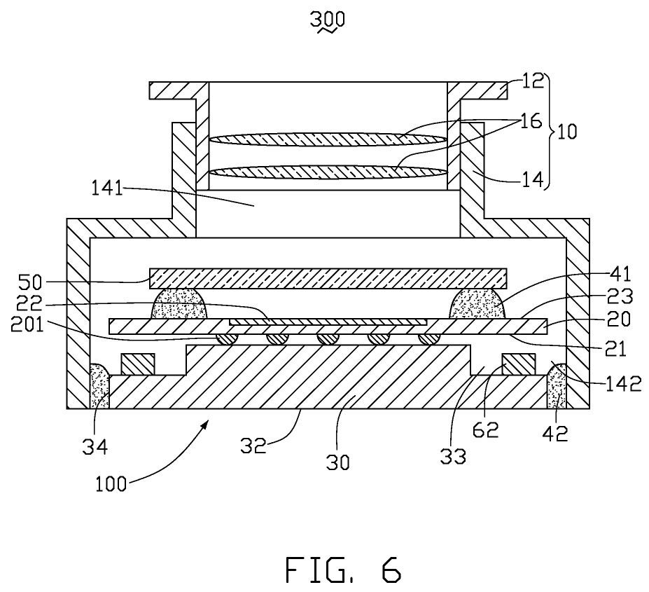

Referring to FIG. 6, a camera module 300 having the image sensor package structure 100 of the first present embodiment is disclosed. The camera module 300 includes the image sensor package structure 100 and a lens module 10 incorporated in the image sensor package structure 100. The lens module 10 includes a lens barrel 12, a lens holder 14 and a lens set 16. The lens holder 14 includes a first end 141 and a second end 142. The lens set 16 is attached inside the lens barrel 12. The outer surface of the lens barrel 12 and the inner surface of the lens holder 14 near the first end 141 have screw threads configured for interlocking and zooming for focus.

The camera module 300 further includes a second adhesive 42 applied onto every side surface 34 of the base board 30. The image sensor package structure 100 is attached to the second end 142 of the lens holder 14 by the second adhesive 42. The second end 142 is sealed by the image sensor package structure 100. In this embodiment, the first adhesive 41 and the second adhesive 42 can be a thermosetting adhesive, a UV adhesive, a hot-melt adhesive or a colloidal silica gel.

In these embodiments, the passive component is installed in the depression of the base board and the depression is located below the image sensor. In other words, the passive component is located below the image sensor and need not occupy much additional package size of the base board. Accordingly, the image sensor package size can be reduced.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An image sensor package structure comprising:
a base board having a top surface, a bottom surface and a side surface, at least one depression being formed in the border of the top surface and the side surface;
an image sensor disposed above the depression and carried by the top surface of the base board, the image sensor being mechanically and electrically connected to the base board; and
at least a passive component disposed in the at least one depression and electrically connected to the base board.

2. The image sensor package structure as claimed in claim 1, wherein the depression is partly formed in the side surface.

3. The image sensor package structure as claimed in claim 1, wherein the depression is fully covered by the image sensor in a top-down projection.

4. The image sensor package structure as claimed in claim 1, wherein the depression is partly covered by the image sensor in a top-down projection.

5. The image sensor package structure as claimed in claim 1, wherein the image sensor includes a number of soldering points on a bottom surface thereof configured for mechanically and electrically connecting to the base board.

6. The image sensor package structure as claimed in claim 5, wherein the soldering points are one of ball grid array, leadless chip carrier and lead frame package type.

7. The image sensor package structure as claimed in claim 1, wherein a height of the depression is essentially equal to that of the passive component.

8. The image sensor package structure as claimed in claim 1, wherein the image sensor package structure further comprises a transparent component attached on the image sensor configured for filtering incoming light.

9. The image sensor package structure as claimed in claim 8, wherein the transparent component is attached to an upper surface of the image sensor, the upper surface being away from the base board.

10. The image sensor package structure as claimed in claim 8, wherein the transparent component is attached to a non-sensor area of the image sensor.

11. A camera module comprising the image sensor package structure as claimed in claim 1 and a lens module; the lens module comprising a lens barrel, a lens holder and a lens set, the lens set being attached inside the lens barrel and the lens barrel being installed in the lens holder, the image sensor package structure being installed inside the lens holder and adjacent to the lens barrel.

12. The camera module as claimed in claim 11, wherein the lens holder comprises a first end and a second end, the lens barrel being installed in the first end of the lens holder, the image sensor package structure being installed in the second end of the lens holder.

13. The camera module as claimed in claim 11, wherein the image sensor package structure seals the second end of the lens holder by an adhesive.

14. A camera module comprising:
a lens module comprising a lens barrel, a lens holder and a lens set, the lens set being attached inside the lens barrel, the lens barrel being installed in one end of the lens holder;
a base board being attached to an opposite end of the lens holder, the base board having a top surface facing the lens set, a bottom surface and a side surface connecting the top surface with the bottom surface, at least one depression being sunken from the top surface;
an image sensor disposed above the at least one depression and carried by the top surface of the base board, the image sensor being electrically connected to the base board; and
at least one passive component disposed in the at least one depression and electrically connected to the base board.

15. The camera module as claimed in claim 14, wherein the side surface of the base board is attached to an inner sidewall of the lens holder via an adhesive.

16. The camera module as claimed in claim 14, wherein the image sensor comprises a sensor area and a non-sensor area surrounding the sensor area, the at least one depression being located beneath the non-sensor area.

17. The camera module as claimed in claim 16, wherein the at least one depression is defined at a border of the top surface and the side surface.

18. The camera module as claimed in claim 14, wherein the depression is fully covered by the image sensor in a top-down projection.

19. The camera module as claimed in claim 14, wherein the depression is partly covered by the image sensor in a top-down projection.

20. The camera module as claimed in claim 14, wherein the at least one passive component is one of inducer, capacitor and resistant component.
